(19) United States
(12) Patent Application Publication
(10) Pub. No.: US 2005/0160453 A1
(43) Pub. Date: Jul. 21, 2005

(54) Apparatus to change a channel using a channel map based on program genre and method thereof

(76) Inventor: Do-young Kim, Suwon-si (KR)

Correspondence Address: STANZIONE & KIM, LLP, 1740 N STREET, N.W., FIRST FLOOR, WASHINGTON, DC, 20036, US

(21) Appl. No.: 11/016,779

(22) Filed: Dec. 21, 2004

(30) Foreign Application Priority Data
Jan. 15, 2004 (KR) 2004-3052

(51) Int. Cl. H04N 7/173; G06F 13/00; H04N 5/445; G06F 3/00

(52) U.S. Cl. 725/39; 725/38; 725/120; 725/118; 725/45

(57) ABSTRACT

A channel changing apparatus includes a channel map generator to generate a channel map according to a program genre by reading channel information associated with a program information for a plurality of channels extracted from a digital broadcast stream and sorting the channel information for the plurality of channels according to broadcast programs delivered through each of the plurality of channels, a storage unit to store the generated channel map, an input part to receive one of an up and down key signal to change the channel from a viewer input device having a plurality of keys, and a controller to retrieve channel information for a next channel to be changed to according to an order of the channel map and to control the digital broadcast receiver to change the channel depending on the retrieved channel information for the next channel when the key signal is input. Simple selection of the channel up and down keys allows the channel to change. Thus, a viewer can select a favorite channel with convenience.

### CROSS-REFERENCE TO RELATED APPLICATIONS

This application claims the benefit under 35 U.S.C. § 119(a) of Korean Patent Application No. 2004-3052 filed on Jan. 15, 2004 in the Korean Intellectual Property Office, the disclosure of which is incorporated herein by reference in its entirety.

### BACKGROUND OF THE INVENTION

1. Field of the Invention

The present general inventive concept relates generally to an apparatus and method of changing a channel. More specifically, the present general inventive concept relates to a channel changing apparatus that uses a channel map organized according to a program genre so that a viewer can facilely change a channel on a digital broadcast receiver.

2. Description of the Related Art

Unlike analog broadcasts, digital broadcasts generally use a logical channel number for channel tuning, instead of a high frequency channel number i.e., a physical transmission channel (PTC). The logical channel number includes a major channel number and a minor channel number. The major channel number is assigned as a unique number to each broadcaster. The minor channel number is assigned by the broadcaster for implementation of multiple channels with respect to a single high frequency channel.

A Program and System Information Protocol (PSIP) of Advance Television Service Committee (ATSC) standard for a terrestrial digital broadcast defines that a digital transport stream carries major and minor channel numbers, video and audio stream information, and detailed program information. The major channel number is assigned to a 6 MHz band used for the terrestrial broadcast, and the minor channel number is assigned to a digital service channel transmitted through the 6 MHz band.

PSIP data is a collection of tables containing the digital broadcast according to the PSIP and system information (SI) for processing the digital transport stream. The PSIP data is contained in the digital transport stream having a base packet ID (PID). The PSIP data includes a system time table (STT), a rating region table (RRT), an event information table (EIT), a master guide table (MGT), and a virtual channel table (VCT). The STT organizes system time information. The RRT organizes rating information for geographical regions. The EIT organizes detailed information about each program. The MGT provides PID information of the EIT. The VCT organizes information (such as the number of channels, video PID, audio PID, and PCR PID) about virtual digital channels in the single high frequency channel.

Channel information about channels contained in the digital transport stream is acquired from the SI. The channel information includes logical and physical channel numbers, video, audio, and PCR PIDs, a broadcaster assigned with a channel, and detailed information about a program carried by the channel. The detailed information about the program contains a title, a genre, and a start time.

In order to tune a channel to a logical channel number selected by a viewer on a digital broadcast receiver, the digital broadcast receiver is first tuned to a physical channel number (i.e., the single high frequency channel) that corresponds to the logical channel number, since the logical channel number is not in the high frequency band. Packet IDs including video, audio, and PCR PIDs, are set to extract a program corresponding to a selected minor channel from the digital transport stream received through the tuned physical channel. Thus, the program corresponding to the selected minor channel is output by selectively decoding video and audio data of the selected minor channel.

A channel map may be provided as the program decoding the video and audio data. The channel map organizes information on tunable channels on the digital broadcast receiver, and provides the logical channel number corresponding to the physical channel number and broadcast information. When the viewer requests a channel change to the digital broadcast receiver by either pressing channel up and down key or manually inputting a desired channel number using a remote controller or a front panel, the digital broadcast receiver changes to the desired channel by acquiring a corresponding physical channel number based on the channel map and tuning to the physical channel number on the high frequency band. The digital broadcast receiver then extracts a program corresponding to the logical channel number.

FIG. 1 illustrates a conventional channel map of the digital broadcast receiver. Referring to FIG. 1, the conventional channel map for the digital broadcast arranges data in an order based on the logical or physical channel number, and includes channel information for a channel change, such as major and minor channel numbers corresponding to the physical transmission channel PTC (i.e., the physical channel number), a program name, a broadcaster, video PID, audio PID, and PCR PID.

Since the single high frequency channel (i.e., physical channel) may correspond to a plurality of logical channels in the digital broadcast, a total number of channels becomes considerably greater. Hence, an electronic program guide (EPG) is provided for searching channels soso that a desired channel may be selected. Specifically, the broadcaster transmits EPG information through each high frequency channel. The digital broadcast receiver receives and stores the EPG information and displays it on a screen when the viewer requests the EPG information. The EPG information allows the viewer to search programs conveyed through the plurality of logical channels corresponding to the single high frequency channel and to select the desired channel. However, when the viewer attempts to change the channel using the EPG, several additional processes need to be performed and the viewer typically needs to manually input more numbers.

If the viewer presses the channel up and down key and requests the channel change, the digital broadcast receiver generally changes channels in sequence from a current channel to a next channel one by one according to the logical or physical channel number based on the channel map as illustrated in FIG. 1. The viewer does not have to memorize all the channel numbers in order to change the channel, and the channel is changed without additional key manipulation compared to when the channel is changed using the EPG information. As a result, most viewers prefer to change the channel using the channel map.

However, it is estimated that the total number of channels of the digital broadcast is about ten times as many as the number of channels in a current analog broadcast. Therefore, when the viewer attempts to change to the desired channel by pressing the channel up and down keys, the channels are changed in sequence according to the physical or logical number, regardless of the viewer's favorite programs, since changing the channel depends on the physical or logical channel number and not on the program carried on the channel.

### SUMMARY OF THE INVENTION

The present general inventive concept provides a channel changing apparatus and method using a channel map organized according to a program genre in a digital broadcast receiver so that a viewer can easily select a channel.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a channel changing apparatus to change a channel of a digital broadcast receiver using a channel map organized according to a program genre, the channel changing apparatus comprising a channel map generator to generate the channel map by reading channel information associated with program information for a plurality of channels extracted from a digital broadcast stream and sorting the channel information for the plurality of channels according to broadcast programs delivered through each of the plurality of channels, a storage unit to store the generated channel map, an input part to receive one of up and down key signals to change the channel from a viewer input device having a plurality of keys, and a controller to retrieve channel information for a next channel to be changed to according to an order of the channel map and to control the digital broadcast receiver to change the channel depending on the retrieved channel information for the next channel when the one of the up and down key signals is input.

The channel map generator may comprise a channel information reader to read the channel information associated with the program information for the plurality of channels used to generate the channel map, a channel information sorter to sort the channel information for the plurality of channels according to the program genre of the broadcast programs delivered through each of the plurality of channels, and a channel map output part to output the channel map by organizing the channel information for the plurality of channels according to the program genre of the broadcast programs.

The channel information for each of the plurality of channels includes at least one of a physical channel number, a logical channel number, a video packet ID (PID), an audio PID, a PCR PID, a broadcaster assigned with the channel, a name of the broadcast program delivered through the channel, and the program genre of the broadest program.

The channel map organizes a list of the channel information for the plurality of channels in an order based on channel numbers of the plurality of channels and the channel information for the plurality of channels is sorted according to the program genre including at least one of a drama, a news, a movie, and a sports.

The controller generates the channel map when a key signal requesting the generation of the channel map is received through the input part from the viewer input device.

The key signal requesting the generation of the channel map is generated by selecting a certain input key on the viewer input device. The controller then determines whether the channel map is stored in the storage unit when the key signal requesting the generation of the channel map is received, and the controller controls the channel map generator to update the channel map if the channel map is stored in the storage unit.

The controller reads the channel information for the next channel from the list including the channel numbers of the plurality of channels from the channel map, processes the channel information for the next channel as on-screen display (OSD) data, and displays the processed on-screen display data on a display connected to the digital broadcast receiver.

The foregoing and/or other aspects and advantages of the present general inventive concept may also be achieved by providing a method of changing a channel using a channel map organized according to a program genre in a digital broadcast receiver, which is connected to a display and receives a digital broadcast stream through a tuned channel. The method comprises determining whether an up or down key signal to change the channel is received from a viewer input device comprising a plurality of input keys, determining whether a genre channel input key is selected to change the channel according to the program genre through the viewer input device when the key signal is received, determining whether a channel map to change the channel according to the program genre is pre-generated and stored when the genre channel input key is selected, generating the channel map organized by sorting channel information associated with program information for a plurality of channels extracted from the digital broadcast stream according to broadcast programs delivered through each of the plurality of channels, and retrieving channel information for a next channel to be changed to according to an order of the channel map and changing the channel depending on the retrieved channel information for the next channel.

The generation of the channel map may comprise reading the channel information associated with the program information for the plurality of channels used to generate the channel map, sorting the channel information for the plurality of channels according to the program genre of the broadcast programs delivered through each of the plurality of channels, and outputting the channel map by organizing the channel information for the plurality of channels according to the program genre of the broadcast programs.

The channel information for each of the plurality of channels may include at least one of a physical channel number, a logical channel number, a video packet ID (PID), an audio PID, a PCR PID, a broadcaster assigned with the channel, a name of the broadcast program delivered through the channel, and the program genre of the broadcast program.

The channel map organizes a list in an order based on channel numbers of the plurality of channels, and the channel information for the plurality of channels is sorted according to the program genre including at least one of a drama, a news, a movie, and a sports.

The method of changing the channel may further comprise updating the channel map using updated channel information for the plurality of channels used to generate the channel map and reading updated program information associated with the updated channel information extracted from the digital broadcast stream received through each of the plurality of channels. This allows the channel map to be updated when one or more of the broadcast programs delivered through the plurality of channels have ended and one or more new broadcast programs have begun.

The method of changing the channel may further comprise reading the channel information for the next channel in the channel map, processing the channel information for the next channel as an on-screen display (OSD) data, mixing the OSD data with a broadcast program delivered through the next channel, and displaying the mixed data on the display.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a channel map used to change a channel in a conventional digital broadcast receiver;

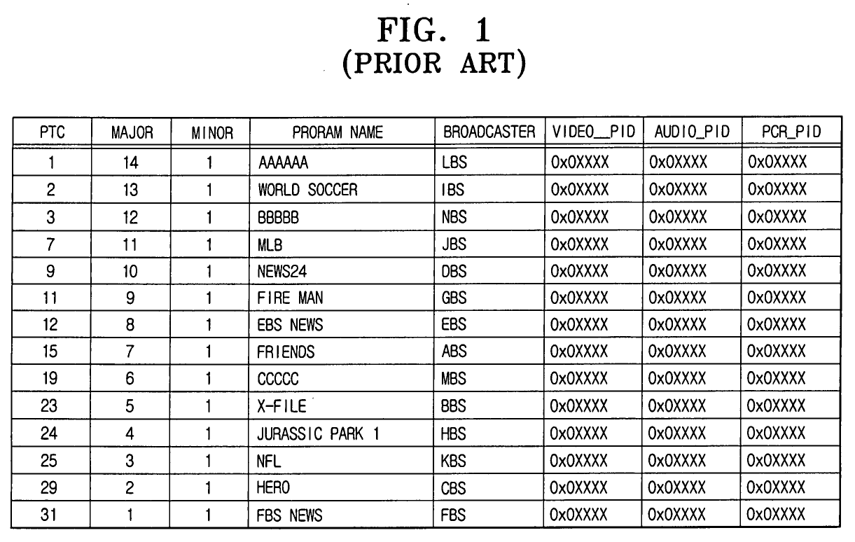

FIG. 2 illustrates a block diagram of a digital broadcast receiver employing a channel changing apparatus according to an embodiment of the present general inventive concept;

FIG. 3 illustrates a channel map organized according to a program genre according to an embodiment of the present general inventive concept;

FIG. 4 illustrates a channel change of the digital broadcast receiver of FIG. 2; and

FIG. 5 illustrates a method of changing a channel according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the drawings.

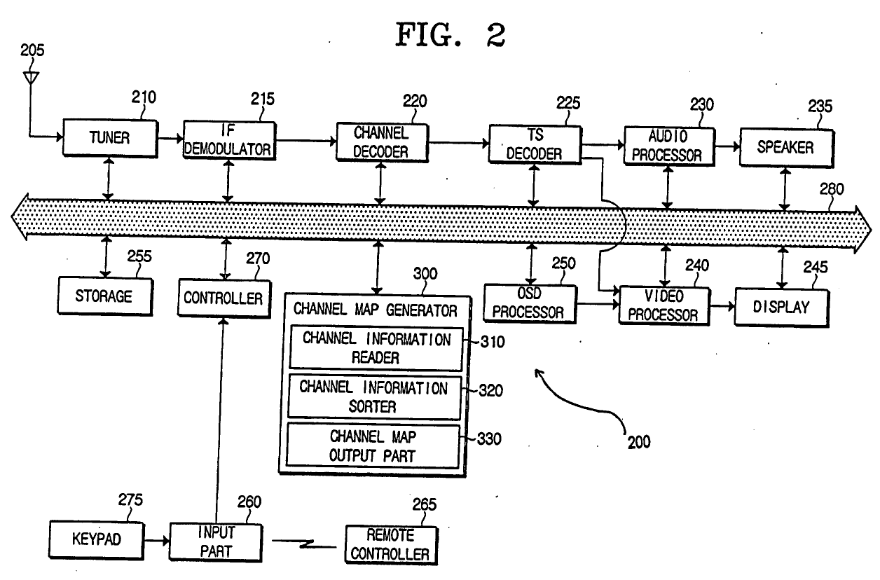

FIG. 2 is a block diagram of a digital broadcast receiver 200 according to an embodiment of the present general inventive concept.

Referring to FIG. 2, the digital broadcast receiver 200 includes a tuner 210, an intermediate frequency (IF) demodulator 215, a channel decoder 220, a transport stream (TS) decoder 225, an audio processor 230, a speaker 235, a video processor 240, a display 245, an on-screen display (OSD) processor 250, a storage unit 255, an input part 260, a remote controller 265, a controller 270, a keypad 275, and a channel map generator 300.

The digital broadcast receiver 200 may correspond to a set-top box such as a digital satellite receiver, a wired/radio digital table broadcast receiver, or a web TV receiver. The digital broadcast receiver 200 is connected with the display 245. The display 245 may be TV connected through a wired or wireless connection to the digital broadcast receiver 200, which outputs video and audio signals to the TV.

The tuner 210 tunes to one radio frequency (RF) channel from an RF broadcast stream received via an antenna 205, using a tuning control signal input from the controller 270, which will be described below. The tuner 210 outputs an intermediate frequency (IF) signal of the tuned RF channel.

The IF demodulator 215 converts the IF signal output from the tuner 210 to a baseband signal and outputs the converted baseband signal.

The channel decoder 220 decodes the baseband signal output from the IF demodulator 215 and regenerates a data bit sequence. The regenerated data bit sequence is input to the transmit stream (TS) decoder 225. When programs of a plurality of minor channels are received through the tuned RF channel, the TS decoder 225 selects a program according to a selection made by the controller 270 and outputs audio and video data of the selected program.

The audio data in the TS decoder 225 is input to the audio processor 230, and the video data is input to the video processor 240. Additional data may be input to the controller 270, such as an electronic program guide (EPG) and/or various system information (hereinafter referred to as program information) containing PSIP data including tables of information about programs consistent with MPEG standard. The program information is input to the channel map generator 300.

The audio processor 230 decodes the audio data input from the TS decoder 225 according to the MPEG standard or Dolby AC-3 standard and outputs amplified sound through the speaker 235.

The video processor 240 decodes the video data input from the TS decoder 225 according to the MPEG standard, and amplifies and outputs the decoded video data to the display 245. The video processor 240 combines the decoded video data with on-screen display (OSD) data of the OSD processor 250, which will be explained below, and outputs the combined data to the display 245.

The OSD processor 250 creates an OSD screen using data provided by the controller 270 to display information in a graphic or text form depending on a selection signal. The generated OSD data generated by the OSD processor 250 to create the OSD screen is input to the video processor 240.

The storage unit 255 includes a nonvolatile memory, such as a flash read-only memory (ROM), to store a control program of the controller 270, and a volatile memory, such as a random-access memory (RAM), to temporarily store data relating to program execution of the controller 270. The storage unit 255 of the present embodiment stores a channel map, which is organized according to a program genre and generated in the channel map generator 300. The storage unit 255 may also store tuner setup information according to the RF broadcast stream and the tuned RF channel.

The input part 260 receives a key signal from the keypad 275 and/or the remote controller 265 and outputs the received key signal to the controller 270.

The remote controller 265 may be provided with function keys and number keys to select various functions supported by the digital broadcast receiver 200. In particular, the remote controller 265 includes channel up and down keys to change the channel. The remote controller 265 of the present embodiment may be similar to a general remote controller. However, the remote controller 265 may have a key to organize the channel map according to the program genre. The keypad 275 may include a plurality of keys installed on the digital broadcast receiver 200 through wired connections so that the key signal is input to the input part 260 when a viewer presses at least one of the plurality of keys.

The controller 270 performs operations of a control command input from the remote controller 265, depending on the control program stored in the storage unit 255. The controller 270 controls overall operation of the digital broadcast receiver 200 based on the control program.

The channel map generator 300 includes a channel information reader 310, a channel information sorter 320, and a channel map output part 330. The channel information reader 310 reads channel information for a plurality of channels to generate the channel map according to the program genre from the program information input from the TS decoder 225. The plurality of channels may be a plurality of logical channels that correspond to one or more physical transmission channels in a high frequency band. The channel information for the plurality of channels may include a physical channel number, a logical channel number, a video packet ID (PID), an audio PID, a PCR PID corresponding to the channel, a broadcaster assigned to the channel, a title of a broadcast program delivered through the channel, and the program genre for the broadcast program. The channel information for each of the plurality of channels may include other information as needed.

The channel information sorter 320 sorts the channel information for the plurality of channels read by the channel information reader 310 in an order according to the program genre. The program genre used to sort the channel information for the plurality of channels may include drama, news, movies, sports, etc.

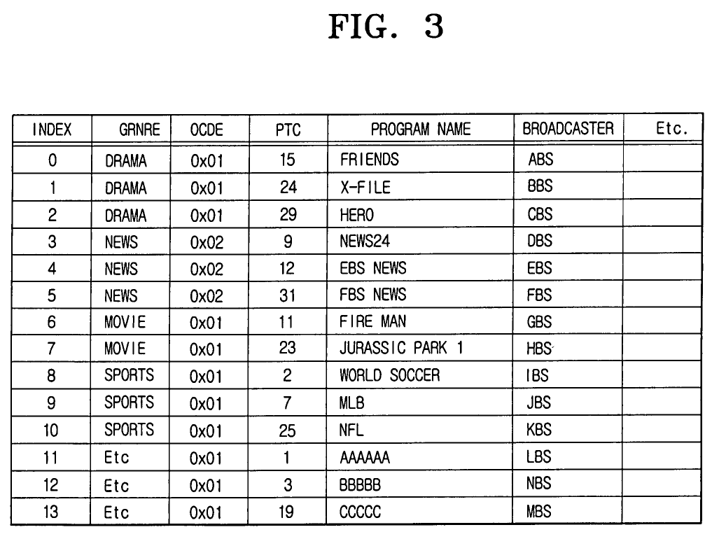

FIG. 3 illustrates a channel map organized according to the program genre. Referring to FIGS. 2 and 3, the program information is sorted according to the program genre in an order of drama, news, movies, and sports. The program information may include a code of the program genre, a physical transmission channel (PTC), a program name, and a broadcaster according to an index of the channel map. Other programs can be added to the channel map.

The channel map output part 330 outputs the channel map organized according to the program genre. The output channel map is stored in the storage unit 255. When the channel is changed using the channel map according to an embodiment of the present general inventive concept, the viewer can search channels of a favorite program genre and can easily select a desired channel since channels of the same program genre are presented to the viewer in the channel map order.

As illustrated in FIG. 2, the tuner 210, the intermediate frequency (IF) demodulator 215, the channel decoder 220, the transport stream (TS) decoder 225, the audio processor 230, the video processor 240, the on-screen display (OSD) processor 250, the storage unit 255, and the channel map generator 300 may be interconnected through a bus 280 connected to the controller 270.

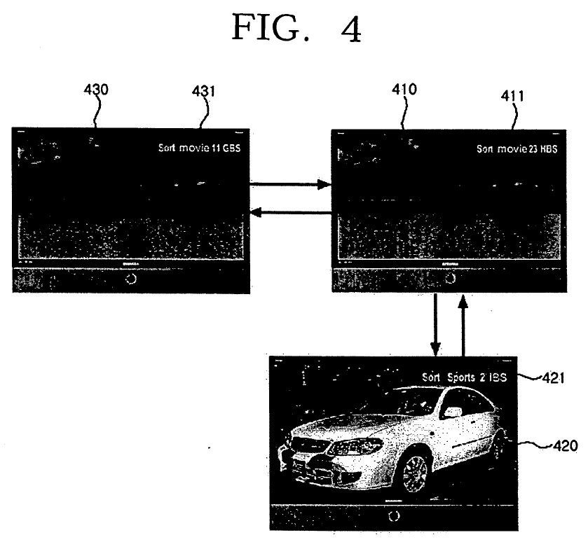

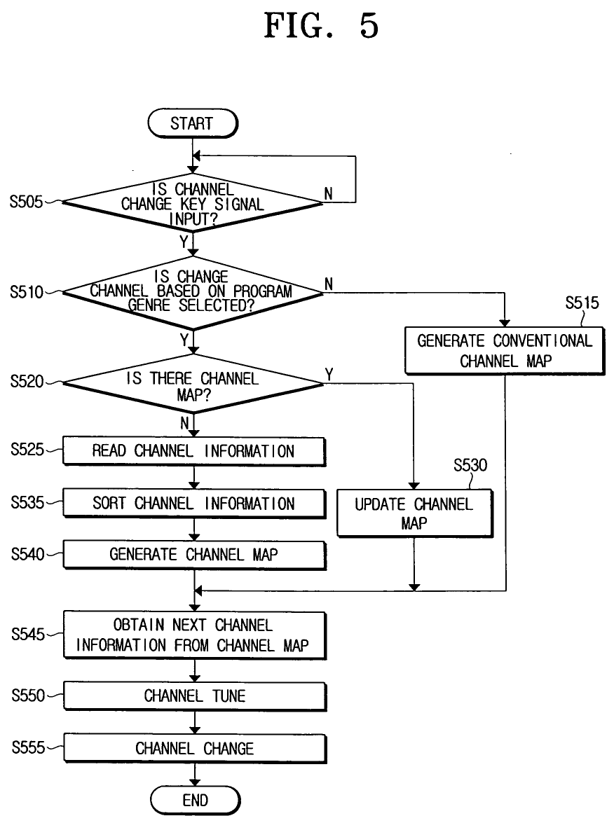

FIG. 4 illustrates a channel change operation of the digital broadcast receiver 200 of FIG. 2, and FIG. 5 is a flowchart illustrating a method of changing the channel of the digital broadcast receiver 200 according to the present embodiment of the general inventive concept.

When the viewer presses the channel up or down key on the remote controller 265 or the keypad 275 and requests a channel change operation, the input part 260 sends a key signal corresponding to the channel up or down key to the controller 270. At operation S505, the controller 270 determines whether the key signal is input by the input part 260. At operation S510, if the controller 270 determines that the key signal is input by the input part 260, the controller 270 determines whether the channel change operation using the channel map according to the program genre is selected, instead of a conventional channel change operation. The conventional channel change operation changes the channel according to an order defined by channel numbers.

The viewer may preset the channel change operation to use the channel map according to the program genre, by pressing a particular key or using a menu of the remote controller 265 or the keypad 275, before pressing the channel up or down key. The particular key may be disposed at a suitable position on the remote controller 265 or the keypad 275 so that the viewer can facilely select either the conventional channel change operation or the channel change operation of the present embodiment of the general inventive concept.

If the channel change operation of the present embodiment of the general inventive concept is not selected, the digital broadcast receiver 200 generates a conventional channel map at operation S515 and changes channels according to the conventional channel map.

At operation S520, if the channel change operation of the present embodiment of the general inventive concept is selected, the controller 270 searches the storage unit 255 and determines whether the channel map organized according to the program genre including the plurality of channels to be changed is stored in the storage unit 255 in response to the key signal of the channel up and down input from the viewer. If the controller 270 determines that the channel map including the plurality of channels to be changed is stored in the storage unit 255, the controller 270 controls the channel map generator 300 to update an index of the channel map at operation S530. The channel map generator 300 updates the index of the channel map stored in the storage unit 255 by reading necessary channel information from updated program information provided from the transport stream (TS) decoder 225.

If a latest update has been performed within a certain time, an additional update may be omitted. The controller 270 may also control the channel map generator 300 to update the channel map at a certain period without receiving the key signal from the input part 260. The certain period may be predetermined or random. The controller 270 may also control the channel map generator 300 to update the channel map when the viewer presses the channel up and down keys.

If the channel map according to the program genre is not stored in the storage unit 255, the controller 270 controls the channel map generator 300 to generate the channel map organized according to the program genre. At operation S525, the channel information reader 310 reads the necessary channel information for the plurality of channels from the program information that is split and decoded from the digital broadcast stream. The plurality of channels may be a plurality of logical channels that correspond to one or more physical transmission channels in the high frequency band.

The channel information for each of the plurality of channels may include the physical channel number, the logical channel number, the video packet ID (PID), the audio PID, and the PCR PID corresponding to the channel, the broadcaster assigned with the channel, the title of the broadcast program delivered through the channel, and the program genre of the broadcast program. The channel information for the plurality of channels may include other information as needed.

At operation S535, the channel information sorter 320 sorts the channel information for the plurality of channels according to the program genre of the broadcast programs delivered through each of the plurality of channels. At operation S540, the channel map output part 330 generates the channel map organizing the channel information for the plurality of channels in an order based on the physical channel numbers or the logical channel numbers of the plurality of channels according to each program genre and stores the generated channel map in the storage unit 255.

When the digital broadcast receiver is installed and the channel map is initially generated based on the program genre, the program information on receivable channels may be obtained using an automatic tuning device provided on the digital broadcast receiver. The channel map according to an embodiment of the present general inventive concept may be generated by reading the necessary channel information from the program information for the receivable channels. Since automatically tuning the receivable channels is well known to those skilled in the art, description thereof will be omitted.

At operation S545, the controller 270 looks up the channel map which is generated in the channel map generator 300 and stored in the storage unit 255 and retrieves the physical channel number corresponding to a next channel to be changed to from a current channel in the order of the index of the channel map. At operation S550, the controller 270 controls the tuner 210 to tune the RF band according to the physical channel number of the next channel. At operation S555, the controller 270 retrieves and sets the video packet ID (PID), the audio PID, and the PCR PID of the next channel from the index of the channel map stored in the storage unit 255, and extracts a packet stream corresponding to the logical channel number of the next channel from the digital broadcast stream received through the tuned RF channel (i.e., the physical transmission channel) in order to change the current channel to the next channel.

The controller 270 controls the on screen display (OSD) processor 250 to generate the OSD data containing the channel information for the next channel. The generated OSD data is supplied to the video processor 240, mixed with video data received through the next channel and processed, and is displayed on the display 245 as OSD information.

Referring to FIG. 4, channel information 411 for the current channel is displayed as an on screen display (OSD) form on a screen 410 corresponding to the current channel displayed on the display 425. By way of example, the program genre, the physical channel number, and the broadcaster are displayed. Referring back to FIG. 3, the physical channel number of the current channel is 23, the broadcaster is HBS, and the program genre is movie. If the viewer presses the channel up key, the channel is changed to a channel higher than the current channel in the order of the index of the channel map (i.e., the next channel). The physical channel number of the higher channel is 11, the broadcaster is GBS, and the program genre is movie. As a result, the display 245 displays OSD data 431 including channel information based on the channel map on a screen 430 of FIG. 4. If the viewer presses the channel down key with the screen 410 of the current channel being displayed, the channel is changed to a channel lower than the current channel in the order of the index of the channel map (i.e., the next channel). The physical channel number of the lower channel is 2, the broadcaster is IBS, and the program genre is sports. The display 245 displays a screen 420 of the lower channel as illustrated in FIG. 4.

In light of the foregoing, the channel map is organized by sorting the channel information for the plurality of channels according to the program genre. A simple selection of the channel up and down keys allows the channel to be changed using the channel map. Thus, the viewer can select their favorite channels with convenience without having to channel through all the channels.

The viewer can select their favorite channels with convenience and efficiency since the viewer can search channels of the same program genre using the channel map according to the present general inventive concept.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A channel changing apparatus to change a channel of a digital broadcast receiver using a channel map, comprising:
a channel map generator to generate a channel map organized according to a program genre by reading channel information associated with program information for a plurality of channels extracted from a digital broadcast stream and sorting the channel information for the plurality of channels according to broadcast programs delivered through each of the plurality of channels;
a storage unit to store the generated channel map;
an input part to receive one of up and down key signals to change the channel; and
a controller to retrieve channel information for a next channel to be changed to according to an order of the channel map and to control the digital broadcast receiver to change the channel depending on the retrieved channel information for the next channel when the key signal is input.

2. The channel changing apparatus of claim 1, wherein the channel map generator comprises:
a channel information reader to read the channel information associated with the program information for the plurality of channels used to generate the channel map;
a channel information sorter to sort the channel information for the plurality of channels according to the program genre of the broadcast programs delivered through each of the plurality of channels; and
a channel map output part to output the channel map by organizing the channel information for the plurality of channels according to the program genre of the broadcast programs.

3. The channel changing apparatus of claim 1, wherein the channel information for each of the plurality of channels includes at least one of a physical channel number, a logical channel number, a video packet ID, an audio packet ID, a PCR packet ID, a broadcaster assigned with the channel, a name of the broadcast program delivered through the channel, and the program genre of the broadcast program.

4. The channel changing apparatus of claim 1, wherein the channel map organizes a list of the channel information for the plurality of channels in an order based on channel numbers of the plurality of channels and the channel information for the plurality of channels is sorted according to the program genre including at least one of a drama, a news, a movie, and a sports.

5. The channel changing apparatus of claim 1, further comprising:
a view input device having a plurality of keys,
wherein the controller generates the channel map when a key signal requesting the generation of the channel map is received through the input part from the view input device.

6. The channel changing apparatus of claim 5, wherein the key signal requesting the generation of the channel map is generated by selecting a certain input key on the view input device.

7. The channel changing apparatus of claim 5, wherein the controller determines whether the channel map is stored in the storage unit when the key signal requesting the generation of the channel map is received, and the controller controls the channel map generator to update the channel map if the channel map is stored in the storage unit.

8. The channel changing apparatus of claim 1, wherein the controller reads the channel information for the next channel from a list including channel numbers of the plurality of channels from the channel map, processes the channel information for the next channel as on-screen display data, and displays the processed on-screen display data on a display connected to the digital broadcast receiver.

9. The channel changing apparatus of claim 1, further comprising:
a display to display the channel map.

10. The channel changing apparatus of claim 9, wherein the display displays a screen including program genre.

11. The channel changing apparatus of claim 9, wherein the display displays a screen corresponding to the respective channels according to the order of the channel map organized by the program genre.

12. The channel changing apparatus of claim 1, further comprising:
an on-screen display processor to determine an on screen data screen using information provided by the controller including the channel information for at least a current channel and the next channel.

13. The channel changing apparatus of claim 1, further comprising:
a view input device comprising one of a keypad and a remote controller, which has a key to organize the channel map according to the program genre.

14. The channel changing apparatus of claim 1, wherein the program genre include at least one of drama, news, movies, and sports.

15. The channel changing apparatus of claim 1, wherein the program information associated with the channel information for each of the plurality of channels includes at least one of a program genre code, a physical transmission channel, a program name, and a broadcaster.

16. The channel changing apparatus of claim 1, wherein the channel map comprises an index of the plurality of channels including a predetermined number of index portions to correspond to a predetermined number of program genre, and at least one of the channel information for the plurality of channels and the program information for the plurality of channels is stored in the predetermined number of index portions of the index according to the program genre of the broadcast programs delivered through each of the plurality of channels.

17. The channel changing apparatus of claim 1, wherein the controller controls the channel map generator to update the channel map when the key signal is received.

18. The channel changing apparatus of claim 1, wherein the controller controls the channel map generator to update the channel map periodically.

19. A digital broadcast receiver to receive one or more digital broadcast streams corresponding to one or more radio frequency channels and the one or more digital broadcast streams including a plurality of channels delivering a plurality of broadcast programs, the digital broadcast receiver comprising:
a channel map generator to generate a channel map to organize channel information for a plurality of channels into a channel order according to a program genre.

20. The receiver of claim 19, wherein the program genre comprises a first program genre and a second program genre and the channel order includes a first and a second groups of channels that correspond to the first and second program genre so that the plurality of channels are ordered according to channel numbers within the first and second groups, respectively.

21. The receiver of claim 19, wherein the channel information for each of the plurality of channels includes at least two of video information, audio information, program information, and a channel number.

22. The receiver of claim 21, wherein the channel number includes at least one of a logical channel number and a physical channel number.

23. The receiver of claim 19, further comprising:
a storage unit to store the channel map organized according to the program genre.

24. The receiver of claim 19, wherein the channel map generator comprises:
a channel information reader to read the channel information for the plurality of channels;
a channel information sorter to sort the channel information for the plurality of channels according to the program genre of the broadcast programs; and
a channel map output part to output the channel map by organizing the channel information of the plurality of channels according to the program genre of the broadcast programs.

25. The receiver of claim 19, further comprising:
a controller to retrieve channel information for a next channel according to the channel order and to change the channel from a current channel to the next channel.

26. The receiver of claim 19, further comprising:
an on-screen display processor to retrieve channel information for a current channel and to cause the channel information for the current channel to be displayed.

27. The receiver of claim 19, wherein the channel order is organized by program genre groupings and channel numbers within the respective program genre groupings.

28. The receiver of claim 19, wherein the channel map generator generates a second channel map to organize the channel information for the plurality of channels into a second channel order according to an ascending or descending order regardless of the program genre.

29. The receiver of claim 28, wherein the channel map genrator selectively generates at least one of the channel map and the second channel map.

30. The receiver of claim 28, further comprising:
a display to selectively display at least one of the channel map and the second channel map.

31. A method of changing a channel using a channel map in a digital broadcast receiver, which is connected to a display and receives a digital broadcast stream through a tuned channel, the method comprising:
determining whether one of an up and down key signal for to change the channel is received from a viewer input device comprising a plurality of input keys;
determining whether a genre channel input key is selected to change the channel according to a program genre through the viewer input device when the key signal is received;
determining whether a channel map to change the channel according to the program genre is pre-generated and stored when the genre channel input key is selected;
generating a channel map organized by sorting channel information associated with program information for a plurality of channels extracted from the digital broadcast stream according to broadcast programs delivered through each of the plurality of channels; and
retrieving channel information for a next channel to be changed to according to an order of the channel map and changing the channel depending on the retrieved channel information for the next channel.

32. The method of claim 31, wherein the generation of the channel map comprises:
reading the channel information associated with the program information for the plurality of channels used to generate the channel map;
sorting the channel information for the plurality of channels according to the program genre of the broadcast programs delivered through each of the plurality of channels; and
outputting the channel map by organizing the channel information for the plurality of channels according to the program genre of the broadcast programs.

33. The method of claim 31, wherein the channel information for each of the plurality of channels includes at least one of a physical channel number, a logical channel number, a video packet ID, an audio packet ID, a PCR packet ID, a broadcaster assigned with the channel, a name of the broadcast program delivered through the channel, and the program genre of the broadcast program.

34. The method of claim 31, wherein the channel map organizes a list in an order based on channel numbers of the plurality of channels and the channel information for the plurality of channels is sorted according to the program genre including at least one of a drama, a news, a movie, and a sports.

35. The method of claim 31, further comprising updating the channel map using updated channel information for the plurality of channels used to generate the channel map and reading updated program information associated with the updated channel information extracted from the digital broadcast stream received through each of the plurality of channels.

36. The method of claim 31, further comprising:
reading the channel information for the next channel in the channel map, processing the channel information for the next channel as an on-screen display data, mixing the on-screen display data with a broadcast program delivered through the next channel, and displaying the mixed data on the display.

37. A method of a digital broadcast receiver to receive one or more digital broadcast streams corresponding to one or more radio frequency channels and the one or more digital broadcast streams including a plurality of channels delivering a plurality of broadcast programs, the method comprising:
generating a channel map to organize channel information for a plurality of channels into a channel order according to a program genre.

38. The method of claim 37, wherein the generating of the channel map organizes the channel information for the plurality of channels into the program genre comprising a first program genre and a second program genre and the channel order includes a first and a second groups of channels that correspond to the first and second program genre so that the plurality of channels are ordered according to channel numbers within the first and second groups, respectively.

39. The method of claim 37, wherein the channel information for each of the plurality of channels includes at least two of video information, audio information, program information, and a channel number.

40. The method of claim 39, wherein the channel number includes at least one of a logical channel number and a physical channel number.

41. The method of claim 37, further comprising:
storing the channel map organized according to program genre.

42. The method of claim 37, wherein the generating of the channel map comprises:
reading the channel information for the plurality of channels;
sorting the channel information for the plurality of channels according to the program genre of the broadcast programs; and
outputting the channel map by organizing the channel information of the plurality of channels according to the program genre of the broadcast programs.

43. The method of claim 37, further comprising:
retrieving channel information for a next channel according to the channel order and changing the channel from a current channel to the next channel.

44. The method of claim 37, further comprising:
retrieving channel information for a current channel and displaying the channel information for the current channel.

45. The method of claim 37, wherein the channel order is organized by program genre groupings and channel numbers within the respective program genre groupings.

46. The method of claim 37, further comprising:
generating a second channel map to organize the channel information for the plurality of channels into a second channel order according to an ascending or descending order regardless of the program genre.

47. The method of claim 46, further comprising:
selectively generating at least one of the channel map and the second channel map.

48. The method of claim 46, further comprising:
selectively displaying at least one of the channel map and the second channel map.
